(19) United States
(12) Patent Application Publication
(10) Pub. No.: US 2014/0261193 A1
(43) Pub. Date: Sep. 18, 2014

(54) MULTILAYER PET BED COVER

(71) Applicant: AUDREY ANN SMITH, KENT, WA (US)

(72) Inventor: AUDREY ANN SMITH, KENT, WA (US)

(21) Appl. No.: 14/206,993

(22) Filed: Mar. 12, 2014

Related U.S. Application Data
(60) Provisional application No. 61/784,751, filed on Mar. 14, 2013.

(51) Int. Cl. A01K 1/035

(52) U.S. Cl. CPC A01K 1/0353
USPC 119/28.5

(57) ABSTRACT

Some embodiments of the present disclosure include a multilayer pet bed cover for protecting a pet bed. The pet bed cover may include a shell having an outer layer and an inner layer permanently attached to the outer layer and an opening in the shell configured to allow a bedding material to be inserted into the shell. The inner layer may have a first surface that faces the outer layer, the first surface being laminated with a polyurethane laminate. The first surface of the inner layer may be breathable and may prevent moisture from entering an interior area defined by the shell. In embodiments, a second surface of the inner layer may face the inner area of the shell and may also be laminated.

### RELATED APPLICATION

This application claims priority to provisional patent application U.S. Ser. No. 61/784,751 filed on Mar. 14, 2013, the entire contents of which is herein incorporated by reference.

### BACKGROUND

The embodiments herein relate generally to pet accessories, and more particularly, to a multilayer cover for a pet bed.

Conventional pet beds are notorious for harboring dirt, grime, and odor. Also, pet beds are often difficult to wash, as machine washing a conventional pet bed can ruin the overall look, feel, and function of the bed by warping that is not designed to have a deep clean. Tumble drying is particularly not recommended for conventional pet beds. Although some beds have removable covers, the covers are typically single layer and pets will often scratch at their beds, causing the fabric to tear, degrading the integrity of the cover and of any existing stain resistant coating.

Therefore, what is needed is a removable pet bed cover that is machine washable, while also protecting the inner stuffing or plush contents from being penetrated by dirt, grime, and moisture.

### SUMMARY

Some embodiments of the present disclosure include a multilayer pet bed cover for protecting a pet bed. The pet bed cover may include a shell having an outer layer and an inner layer permanently attached to the outer layer and an opening in the shell configured to allow a bedding material to be inserted into the shell. The inner layer may have a first surface that faces the outer layer, the first surface being laminated with a polyurethane laminate. The first surface of the inner layer may be breathable and may prevent moisture from entering an interior area defined by the shell. In embodiments, a second surface of the inner layer may face the inner area of the shell and may also be laminated.

### BRIEF DESCRIPTION OF THE FIGURES

The detailed description of some embodiments of the invention is made below with reference to the accompanying figures, wherein like numerals represent corresponding parts of the figures.

FIG. 1 is a top perspective view of one embodiment of the present invention shown in use.

FIG. 2 is a bottom perspective view of one embodiment of the present invention shown in use.

FIG. 3 is a perspective view of one embodiment of the present invention, illustrating its assembly.

FIG. 4 is a detail section view of one embodiment of the present invention, taken along line 4-4 in FIG. 3.

FIG. 5 is an exploded view of one embodiment of the present invention.

FIG. 6 is a section view of one embodiment of the present invention, taken along line 6-6 in FIG. 1.

FIG. 7 is a section view of one embodiment of the present invention, taken along line 7-7 in FIG. 1.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to cover and protect a pet bed and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Multilayer Shell

2. Outer Layer

3. Inner Layer

The various elements of the multilayer pet bed cover for protecting a pet bed from dirt, germs, moisture, and odor of the present disclosure may be related in the following exemplary fashion. It is not intended to limit the scope or nature of the relationships between the various elements and the following examples are presented as illustrative examples only.

By way of example, and referring to FIGS. 1-7, some embodiments of the pet bed cover of the present disclosure comprise a shell 10 configured to hold bedding material, stuffing, or a pillow 28, the shell 10 comprising an outer layer 12 attached to an inner layer, wherein the inner layer has a first surface 14 configured to face the outer layer 12 and a second surface 16 configured to face away from the outer layer 12. In embodiments, the shell 10 may further comprise a closing mechanism, such as a flap 22 that is configured to fold over an opening in the shell 10, securing the bedding material, stuffing, or pillow 28 within the shell 10. The flap 22 may be secured in a closed position by a fastener 18 and, in embodiments, is secured in a closed position by a plurality of fasteners 18, as shown in FIGS. 2 and 6. However, in alternate embodiments, the shell 10 may not include either a flap 28 or fasteners 18.

The cover may be made using any suitable method. For example, as shown in FIG. 3, the shell of the cover may be manufactured by securing the outer layer 12 to the first surface 14 of the inner layer, wherein the inner layer and the outer layer 12 are substantially the same size and shape. The outer layer 12 may be permanently attached to the inner layer by any conventional means, such as by using an adhesive or by sewing, and in some embodiments the outer layer 12 is sewn to the inner layer with continuous stitching 24 along the outer edges of the layers. The material may then be folded substantially or entirely in half such that the outer layer 12 is folded against itself. In embodiments, is folded in such a way that the ends of the material do not meet, creating a flap 28 as shown in FIGS. 3 and 5. Once the outer layer 12 is folded against itself, the second surface 16 of the inner layer may temporarily be positioned on the outer surface of the cover, and seams 26 may be created to close the sides of the shell 10, leaving one side of the pillow, such as the side with the flap 28, open to permit a pillow being inserted into the shell 10. In embodiments, the seams 26 may be created by sewing, by using an adhesive, or by using any other suitable technique. The shell 10 may then be turned right-side out, such that the outer layer 12 is on the outer surface of the shell 10 and the seams 26 are positioned within the interior of the shell 10. Alternatively, the seams 26 may be created such that the seams 26 are positioned on the outer surface of the shell 10 when the outer layer 12 is the outer surface of the shell 10.

The outer layer may be made of any suitable material and, in embodiments, is made of a natural and/or synthetic fabric that is both comfortable and visually appealing or decorative. Suitable outer layer materials include those that are machine washable.

The inner layer may be made of material capable of acting as a moisture barrier between the outer layer and the pillow or stuffing to be inserted into the cover. Particularly, at least the first surface of the inner layer may comprise a moisture barrier. For example, the inner layer may be a fabric that is lined or laminated with a polymer, which acts as a moisture barrier to prevent dirt, pet odor, and moisture from penetrating through the inner layer to the stuffing and which also remains breathable. In some embodiments, the inner layer may be a polyurethane laminated fabric having the lamination at least on the first surface of the inner layer, but possibly on the second surface of the inner layer as well. Alternatively, the inner layer may have polytetrafluoroethylene (PTFE) to one or both surfaces of the inner layer. When used, the PTFE may be applied by spraying. In other embodiments, the inner layer may be a GORE-TEX material or may have a GORE-TEX material applied to at least the first surface of the inner layer.

Suitable fasteners for securing a pillow into the cover include any conventionally used fasteners, such as a zipper, a hook and loop fastener like VELCRO, buttons, snaps, ties, hook and eye fasteners, or clips. In embodiments, the cover includes a plurality of buttons 18 configured to engage with button holes 20 on the inner surface of the flap 28 to secure stuffing or a pillow 28 into the shell 10.

The multilayer cover may have any desired size and shape. For example, the cover may be rectangular, square shaped, round, ovular, star-shaped, heart-shaped, or any other desired shape. In some embodiments, the cover may have a size and shape configured to hold a standard pillow. Other embodiments may be configured to hold any type of stuffing or cushion material, such as foam or viscoelastic foam.

To use the cover, an individual would insert a pillow or other stuffing material through the opening on the cover into the interior of the cover, making sure that the outer surface of the cover is on the exterior of the cover. If fasteners are included, the cover may be secured around the pillow or stuffing material and the opening may be secured shut by fastening the fasteners. The cover may then function to protect the pillow or stuffing material from dirt, grime, germs, moisture, stains, and odors. When needed or desired, the pillow or stuffing may be removed from the cover, and the cover may be washed. In embodiments, the cover may be machine washed and tumble dried without causing damage to the cover.

In embodiments, the cover may be used as a cover for a pet bed, keeping the pet bed clean and substantially odor-free even after repetitive use of the bed by a pet. Alternatively, the cover may be used as a pillow case cover for a conventional bedding pillow. In the case of a person drooling or sweating, the cover may protect the pillow from stains and odors caused by drooling, sweating, or the like.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A multilayer pet bed cover for protecting a pet bed, the cover comprising:
a shell comprising:
an outer layer; and
an inner layer attached to the outer layer,
wherein:
an interior of the shell is configured to hold a bedding material; and
the inner layer has at least one breathable surface that is also a moisture barrier configured to protect the bedding material from moisture.

2. The multilayer pet bed cover of claim 1, wherein the at least one breathable surface of the inner layer faces the outer layer.

3. The multilayer pet bed cover of claim 1, wherein the inner layer is a fabric that is laminated with polyurethane on at least one surface, forming the breathable surface that is the moisture barrier.

4. The multilayer pet bed cover of claim 1, wherein the inner layer is a fabric coated with polytetrafluoroethylene on at least one surface, forming the breathable surface that is the moisture barrier.

5. The multilayer pet bed cover of claim 1, further comprising an opening in a surface of the cover, such that the bedding material is removable.

6. The multilayer pet bed cover of claim 5, wherein the opening comprises a fastener configured to close the opening and secure the bedding material in the cover.

7. The multilayer pet bed cover of claim 6, wherein the fastener is a member selected from the group consisting of a snap, a button, a zipper, a tie, a hook and loop fastener, and hook and eye fastener, a clasp, or a combination thereof.

8. A multilayer pet bed cover for protecting a pet bed, the cover comprising:
a shell comprising:
an outer layer; and
an inner layer permanently attached to the outer layer, the inner layer having a first surface that faces the outer layer, the first surface being laminated with a polyurethane laminate; and
an opening in the shell configured to allow a bedding material to be inserted into the shell,
wherein the first surface of the inner layer is breathable and prevents moisture from entering an interior area defined by the shell.

9. The multilayer pet bed cover of claim 8, further comprising a fastener configured to secure the opening shut.

10. The multilayer pet bed cover of claim 8, wherein the inner layer further comprises a second surface that faces the interior area, the second surface being laminated with a polyurethane laminate.
